(19) United States
(12) Patent Application Publication
(10) Pub. No.: US 2016/0380900 A1
(43) Pub. Date: Dec. 29, 2016

(54) METHOD AND APPARATUS FOR MANAGING TRAFFIC RECEIVED FROM A CLIENT DEVICE IN A COMMUNICATION NETWORK

(71) Applicant: TELEFONAKTIEBOLAGET L M ERICSSON (publ), Stockholm (SE)

(72) Inventors: Johan KOLHI, Stockholm (SE); Andreas LJUNGGREN, Stockholm (SE); Robert SKOG, Stockholm (SE); Michael T. HUBER, Stockholm (SE); Saurabh SINGH, Stockholm (SE)

(73) Assignee: TELEFONAKTIEBOLAGET L M ERICSSON (PUBL), Stockholm (SE)

(21) Appl. No.: 14/763,277

(22) PCT Filed: Jun. 26, 2015
(86) PCT No.: PCT/EP2015/064509

§ 371 Date: Jul. 24, 2015

(51) Int. Cl. H04L 12/851; H04L 12/721; H04L 12/825; H04L 29/08

(52) U.S. Cl. CPC H04L 47/24; H04L 67/2842; H04L 45/38; H04L 47/25

(57) ABSTRACT

A method (100), performed in a network node, for managing traffic received from a client device in a communication network is disclosed. The method comprises receiving a traffic flow from a client device (110), analysing the received traffic flow to determine an operating system running on the client device (120), mapping the determined operating system to a client device category (130), and implementing a processing decision for the received traffic flow according to the client device category (140).

Also disclosed are a network node (200, 300) and a computer program product configured, when run on a computer, to carry out a method for managing traffic received from a client device in a communication network.

### TECHNICAL FIELD

The present invention relates to a method for managing traffic received from a client device in a communication network. The present invention also relates to a network node and to a computer program configured to carry out a method for managing traffic received from a client device in a communication network.

### BACKGROUND

Many communication network operators implement traffic optimisation functions in order to improve network and service performance and enhance user experience. Examples of network optimisations include virus checking, content adaptation, and Transparent Internet Caching (TIC). Content Distribution Networks (CDN) are another example of network optimisation functions widely used in the distribution of media content including web pages and audio and video files. When a user initiates an action such as web browsing or media streaming, the user must wait for the network to retrieve the requested content, carry the content across the network to the user and then deliver the content to the user's device. Formed from a large number of servers hosted in geographically distributed data centres, CDNs offer both improved availability and performance by placing regularly accessed content closer to the edge of the communication network, where it may be more quickly and easily delivered to end users. CDNs also relieve pressure on the rest of the network infrastructure, as bandwidth that would be required for delivery of media content is released for other uses.

Media delivery continues to represent a highly significant proportion of all communication network traffic. However, with the growth in Machine Type

Communication (MTC) devices and the Internet of Things (IoT), traffic associated with connected devices and MTC networks is rapidly increasing, and is projected to continue to do so. IoT traffic gains little or no benefit from network optimisation functions designed for user associated content delivery traffic. IoT traffic is often far less sensitive to network delays, and does not require content adaptation or delivery via a CDN. However, there is currently no convenient way for the network to distinguish between traffic that should be subject to network optimisations and traffic which need not be subject to such optimisations. The network can examine the IP address of the source of the traffic, but this will not necessarily enable a distinction to be made. IP addresses for a wide variety of different devices may be allocated from the same ranges and may access the communication network over the same local networks. For example, in a commercial or residential building, mobile phones, laptops, networked video cameras, smart televisions, set top boxes, connected appliances and sensor networks may all run over the same access networks and may have IP addresses allocated from the same range. The network cannot therefore filter out those devices whose traffic would benefit from TIC, virus checking or a CDN from those devices which should simply deliver their data without any optimisation. Without a means for filtering out traffic that will not benefit from network optimisations, such traffic represents an unnecessary drain on resources within network optimisation functions. As IoT and other MTC type traffic increases, it will consume increasing amounts of resources in CDNs and other optimisation functions, and consequently impact negatively upon the perceived performance of the communication network.

### SUMMARY

It is an aim of the present invention to provide methods, apparatus and computer readable media which at least partially address one or more of the challenges discussed above.

According to a first aspect of the present invention, there is provided a method, performed in a network node, for managing traffic received from a client device in a communication network. The method comprises receiving a traffic flow from a client device, analysing the received traffic flow to determine an operating system running on the client device, mapping the determined operating system to a client device category, and implementing a processing decision for the received traffic flow according to the client device category.

In some examples of the invention, the client device category may comprise devices running the determined operating system, such that the processing decision is implemented on the basis of the operating system running on the client device. In other examples, additional inputs to the determined operating system may determine the device category.

According to examples of the invention, analysing the received traffic flow to determine an operating system running on the client device may comprise performing an operating system fingerprinting operation on the received traffic flow.

According to examples of the invention, the operating system fingerprinting operation may comprise one of an active or passive operating system fingerprinting operation.

According to examples of the invention, mapping the determined operating system to a client device category may comprise inputting at least the determined operating system to a mapping function and retrieving a client device category from the mapping function.

According to examples of the invention, mapping the determined operating system to a client device category may further comprise obtaining at least one additional device identification information for the client device and inputting the additional device information to the mapping function. An example of additional device information may comprise device manufacturer. The additional device information may be retrieved from the received traffic flow or may be obtained through querying the client device or another network node.

According to examples of the invention, implementing a processing decision for the received traffic flow according to the client device category may comprise retrieving a processing decision corresponding to the client device category from a memory and applying the retrieved processing decision. The processing decision may for example be retrieved from a database or decision tree, which may be populated and updated by a network operator. In further examples, the network node may update the database or decision tree, for example on the basis of a machine learning operation.

According to examples of the invention, the method may further comprise applying the retrieved processing decision for a traffic flow to the client device.

According to examples of the invention, applying the retrieved processing decision may comprise at least one of applying or withholding a processing function corresponding to the processing decision. In examples of the invention, applying a processing decision may comprise applying or withholding multiple processing functions corresponding to the processing decision.

According to examples of the invention, the processing function may result in at least one of caching the received traffic flow, adjusting a payload of the received traffic flow, adjusting a speed of transmission of the received traffic flow, and/or adjusting a forwarding route of the received traffic flow.

According to examples of the invention, adjusting a forwarding route of the received traffic flow may comprise one of including or excluding a network optimisation function in the forwarding route of the received traffic flow.

According to examples of the invention, a network optimisation function may comprise at least one of a Content Delivery Network, a virus check, Transparent Internet Caching, and/or content adaptation.

According to examples of the invention, adjusting a forwarding route of the received traffic flow may comprise including a Virtual Private Network in the forwarding route of the received traffic flow.

According to examples of the invention, adjusting a speed of transmission of the received traffic flow may comprise selecting communication links for the received traffic flow having a different bandwidth.

According to examples of the invention, adjusting a speed of transmission of the received traffic flow may comprise adjusting a priority with which the received traffic flow will be forwarded.

According to examples of the invention, adjusting a payload of the received traffic flow may comprise performing at least one of data compression, Maximum Transmission Unit size adjustment, image resizing, and/or content adaptation.

According to examples of the invention, the client device category may categorise the client device according to at least one of device operating system, device type, device purpose, device mobility, device communication pattern, associated devices, associated equipment, and/or network subscription.

According to examples of the invention, the network node may comprise a proxy server.

According to another aspect of the present invention, there is provided a computer program configured, when run on a computer, to carry out a method according to the first aspect of the present invention.

According to another aspect of the present invention, there is provided a computer program product comprising computer readable material having stored thereon a computer program according to the preceding aspect of the present invention.

According to another aspect of the present invention, there is provided a network node for managing traffic received from a client device in a communication network, the network node comprising a processor and a memory, the memory containing instructions executable by the processor such that the network node is configured to receive a traffic flow from a client device, analyse the received traffic flow to determine an operating system running on the client device, map the determined operating system to a client device category, and implement a processing decision for the received traffic flow according to the client device category.

According to another aspect of the present invention, there is provided a network node for managing traffic received from a client device in a communication network, the network node comprising a receiving unit for receiving a traffic flow from a client device and an analysing unit for analysing the received traffic flow to determine an operating system running on the client device. The network node further comprises a mapping unit for mapping the determined operating system to a client device category, and a processing unit for implementing a processing decision for the received traffic flow according to the client device category.

According to examples of the invention, the analysing unit may be for performing an operating system fingerprinting operation on the received traffic flow.

According to examples of the invention, the analysing unit may be for performing at least one of an active or passive operating system fingerprinting operation.

According to examples of the invention, the mapping unit may be for inputting at least the determined operating system to a mapping function and retrieving a client device category from the mapping function.

According to examples of the invention, the mapping unit may be for obtaining at least one additional device identification information for the client device and inputting the additional device information to the mapping function.

According to examples of the invention, the processing unit may comprise a retrieving unit for retrieving a processing decision corresponding to the client device category from a memory, and an application unit for applying the retrieved processing decision.

According to examples of the invention, the application unit may also be for applying the retrieved processing decision for a traffic flow to the client device.

According to examples of the invention, the application unit may be for performing at least one of applying or withholding a processing function corresponding to the processing decision.

According to examples of the invention, the processing function may result in at least one of caching the received traffic flow, adjusting a payload of the received traffic flow, adjusting a speed of transmission of the received traffic flow, and/or adjusting a forwarding route of the received traffic flow.

According to examples of the invention, adjusting a forwarding route of the received traffic flow may comprise one of including or excluding a network optimisation function in the forwarding route of the received traffic flow.

According to examples of the invention, a network optimisation function may comprise at least one of a Content Delivery Network, a virus check, Transparent Internet Caching, content adaptation.

According to examples of the invention, adjusting a forwarding route of the received traffic flow may comprise including a Virtual Private Network in the forwarding route of the received traffic flow.

According to examples of the invention, adjusting a speed of transmission of the received traffic flow comprises selecting communication links for the received traffic flow having a different bandwidth.

According to examples of the invention, adjusting a speed of transmission of the received traffic flow may comprise adjusting a priority with which the received traffic flow will be forwarded.

According to examples of the invention, adjusting a payload of the received traffic flow may comprise performing at least one of data compression, Maximum Transmission Unit size adjustment, image resizing, and/or content adaptation.

According to examples of the invention, the client device category may categorise the client device according to at least one of device operating system, device type, device purpose, device mobility, device communication pattern, associated devices, associated equipment, and/or network subscription.

According to examples of the invention, the network node may comprise a proxy server.

According to another aspect of the present invention, there is provided a proxy server comprising a network node according to the preceding aspect of the present invention.

### BRIEF DESCRIPTION OF THE DRAWINGS

For a better understanding of the present invention, and to show more clearly how it may be carried into effect, reference will now be made, by way of example, to the following drawings in which:

FIG. 1 is a flow chart illustrating process steps in a method for managing traffic received from a client device in a communication network;

FIG. 2 is a flow chart illustrating additional detail which may be comprised within the method of FIG. 1;

FIG. 3 is a schematic representation of an example of the method of FIG. 1 in operation;

FIG. 4 is a schematic representation of another example of the method of FIG. 1 in operation;

FIG. 5 is a block diagram illustrating functional units in a network node; and

FIG. 6 is a block diagram illustrating functional units in another example of network node.

### DETAILED DESCRIPTION

Aspects of the present invention provide a method which permits the implementation of processing decisions on the basis of a client device category, which category may be mapped from an operating system running on the client device. The operating system running on the client device is determined through analysis of a traffic flow received from the client device. This analysis may for example comprise operating system fingerprinting analysis. Aspects of the present invention thus enable the processing of traffic according to the category of client device with which it originates, so avoiding unnecessary load on optimisation functions from traffic for which such optimisations are unnecessary, and also shortening the route to destination for traffic which does not need network optimisation processing. Processing decisions may also be applied to subsequent traffic sent to the client device, in addition to traffic received from the client device. The method is performed in a network node which may for example be a proxy server. Proxy servers often act a gateway for traffic to enter a communication network managed by a network operator. The implementation of methods according to the present invention at a proxy server may thus enable efficient processing of all traffic passing through the proxy server, directing the traffic towards only those optimising functions which are appropriate for that category of devices.

Some examples of the present invention make use of operating system fingerprinting techniques, and a brief discussion of such techniques is provided below.

All operating systems (OS) have different timing, padding, and ordering of certain packets, as well as other different parameters which may be observed from a close inspection of initial packets in a traffic flow. For example, when communicating over TCP, different OSs may have different Time To Live (TTL) in the IP header and a different TCP window size for the first packet in a TCP session. By examining TCP and UDP traffic to and from a device, the node's OS may thus be identified, or “fingerprinted”. In some examples of the technique, no additional signaling is required, and the fingerprinting process is conducted entirely on the basis of analysis of existing received traffic. This is referred to as passive fingerprinting. In alternative examples, dedicated packets may be sent to the device, and the OS running on the device may be identified from the manner in which the device responds to the dedicated packets. This is referred to as active fingerprinting. OS fingerprinting techniques are used for example in certain firewalls, where access for a user may be granted on the basis of the OS running on the user's device.

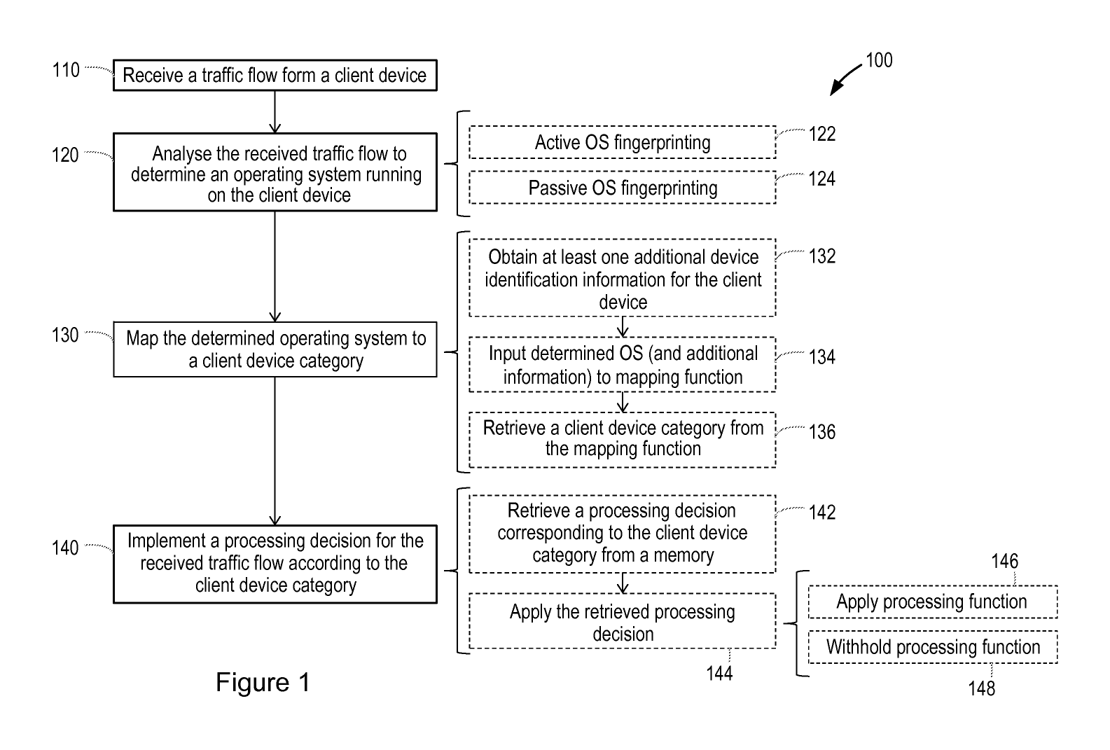

FIG. 1 illustrates an example method 100 for managing traffic received from a client device in a communication network. The method is performed in a network node. In the following discussion, the example of a network node in the form of a proxy server is illustrated but it will be appreciated that this is merely for the purposes of illustration, and the network node may comprise other nodes than a proxy server.

Referring to FIG. 1, in a first step 110, the proxy receives a traffic flow from a client device. The traffic flow may be received via a gateway node or other intermediary node, or may be received directly from the client device. The proxy then analyses the received traffic flow to determine an OS running on the client device in step 120. This analysis may involve performing active OS fingerprinting, in step 122, or passive OS fingerprinting, in step 124. In step 130, the proxy maps the determined operating system to a client device category. In examples of the method 100, mapping may comprise inputting the determined OS to a mapping function in step 134 and retrieving a client device category from the mapping function at step 136. In some examples, the client device category may simply correspond to a particular operating system, such that there is a one to one mapping between determined operating system and device category. In further examples, there may be a many to one mapping, with embedded operating systems corresponding to a first device category of IoT devices and non-embedded operating systems corresponding to a second device category of non-IoT devices.

In further examples of the method 100, mapping the determined operating system to a device category may comprise obtaining at least one additional device identification information for the client device in step 132, and inputting the additional identification information to the mapping function with the determined OS. The additional identification information may enable a one to many mapping between operating system and device category, such that devices running the same operating system but having other differences may be distinguished. One example of an additional identification information may be a manufacturer of the client device. Manufacturer information may enable for example different categories of connected appliance to be distinguished. A client device having an embedded OS and manufactured by an auto manufacturer may be distinguished from a client device having an embedded OS and manufactured by a manufacturer of media appliances or of domestic household appliances. Other examples of additional information may be envisaged, such as whether the client device is designed for mobile or stationary use, any other devices with which the client device is associated as part for example of a network, a communication pattern of the client device, etc. The additional identification information may be extracted from the received traffic flow, or obtained from the client device or another network node following an appropriate query from the proxy. The device category which is returned as a result of the mapping operation may thus classify the client device according to a wide range of factors including operating system, device type, device purpose, device mobility, device communication pattern, associated devices, associated equipment, and/or network subscription.

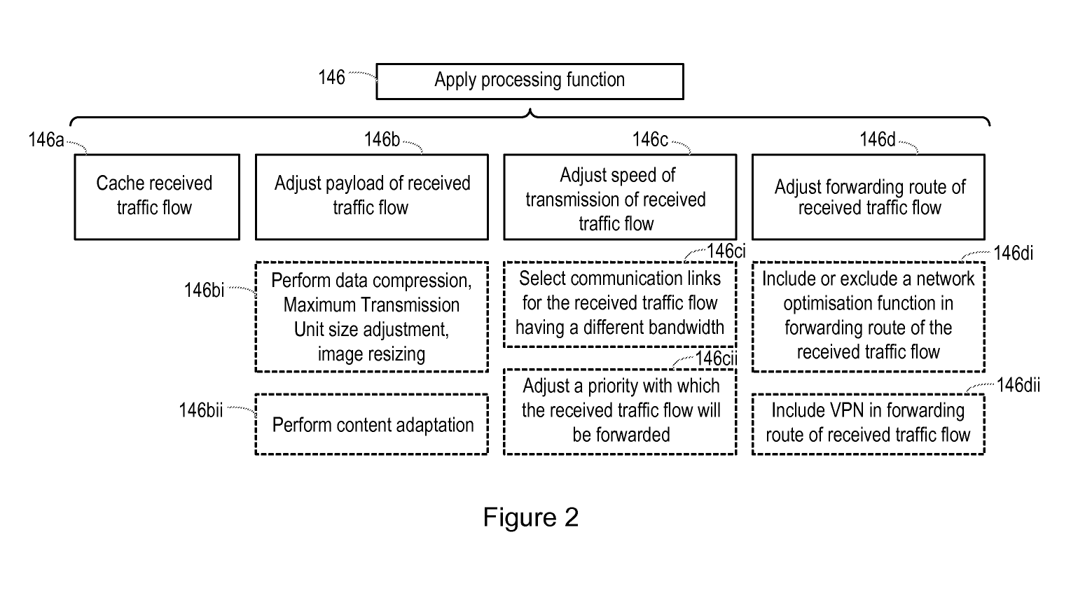

Having mapped the determined OS to a client device category, the proxy then proceeds, in step 140, to implement a processing decision for the received traffic flow according to the client device category. This may comprise retrieving a processing decision corresponding to the client device category from a memory in step 142, and then applying the retrieved processing decision in step 144. A single processing decision may involve the application, in step 146, or withholding, in step 148, of one of more processing functions, which may for example be network optimisation functions. As an example, a network may include a range of network optimisation processing functions, such as TIC, virus check, CDN etc. Any combination of these functions may be appropriate for a particular category of client devices. A first example processing decision may thus comprise the application of virus check and CDN but the withholding of TIC. Another example processing decision may correspond to a device category including IoT devices which have no need of any network optimisation functions, and the processing decision may therefore comprise the withholding of all network optimisation processing functions. The nature and effect of the different processing functions which may be applied or withheld is discussed in further detail below with reference to FIG. 2. In a further step (not shown) the processing decision retrieved at step 142 may also be applied to subsequent traffic flows sent to the client device, in addition to being applied to the traffic flow received from the device. This is discussed in further detail below.

Referring to FIG. 2, the application of a processing function in step 146 may result in a range of actions including caching the received traffic flow at 146a, adjusting a payload of the received traffic flow at 146b, adjusting a speed of transmission of the received traffic flow at 146c and/or adjusting a forwarding route of the received traffic flow at 146d. Caching the received traffic flow at 146a may involve caching all or a part of the received traffic flow, and the received traffic flow may be cached in a CDN dedicated cache or other temporary storage node. Adjusting a payload of the received traffic flow at 146b may involve performing at least one of data compression, Maximum Transmission Unit size adjustment, image resizing etc at 146bi. These actions may be particularly appropriate for sensor data for example, which may benefit from such manipulation before being forwarded to an appropriate server. Adjusting a payload of the received traffic flow may also comprise performing content adaptation of various forms at 146bii.

A speed of transmission of the received traffic flow may be adjusted through traffic shaping. This may for example involve selecting a different bandwidth of communication links in the forwarding route of the traffic flow at 146ci. Low bandwidth links may be selected for traffic such as sensor data, which is relatively low volume, and high bandwidth links may be selected for high volume traffic such as video conferencing. A priority with which the traffic is forwarded may also be adjusted at 146cii such that, in the event of cell congestion, traffic which is highly sensitive to transmission delays may be prioritised over other, less delay sensitive traffic.

A forwarding route of the received traffic flow may be adjusted for example by one of including or excluding a network optimisation function in the forwarding route of the received traffic flow at 146di. A network optimisation function may include a Content Delivery Network, a virus check, Transparent Internet Caching, content adaptation, etc. Thus the received traffic flow may be forwarded to another proxy node where the relevant network optimisation function is carried out, or may be forwarded to a CDN etc. A forwarding route of the received traffic flow may be also be adjusted for example by including a Virtual Private Network in the forwarding route of the received traffic flow at 146dii. IoT traffic is an example of a kind of traffic flow which may be separated out to be forwarded over a VPN to a dedicated server. It will be appreciated that any of the above functions may also be applied to traffic flows being sent to the client device, following application to the received traffic flow.

A result of the application or withholding of the above discussed processing functions is that traffic flows may be processed in a manner appropriate to the category of device with which they originated, and, for subsequent traffic flows, the device to which they are sent. Thus traffic which does not need to be subject to network optimisations can be routed away from such optimisations, reducing unnecessary load on the optimisation functions and freeing processing capacity and bandwidth for traffic which does require the optimisations. Additionally, by avoiding unnecessary optimisation functions, traffic may reach its destination more quickly and efficiently. The variety of options available for mapping a determined operating system to a client device category affords a wide range of options for the management of received traffic flows. In a relatively simple implementation, IoT traffic may be separated from non-IoT traffic, with IoT traffic being forwarded away from network optimisation functions. In a more complicated implementation, a finer granularity may be applied in classifying client devices, as well a greater specificity in the application or withholding of individual processing functions for different device categories.

The logic determining which processing functions are applied to which device categories may be contained in a database or decision tree, which may be stored in a memory of the proxy or in another memory accessible by the proxy. This logic may be dictated by a network operator, and may be updated or adjusted by a network operator. In further examples, machine learning techniques may be used to update the detail of processing decisions, and which processing decisions apply to which device categories. Thus for example, network congestion conditions and/or feedback concerning service performance, network performance or other related factors may be taken into account in updating the logic which determines the application of different processing functions to different device categories. In addition, amendments or updates made to particular client devices or to the functioning of such devices, or to the services offered via such devices, may be taken into account in the processing decisions applied to the device category to which the updated or amended devices belong.

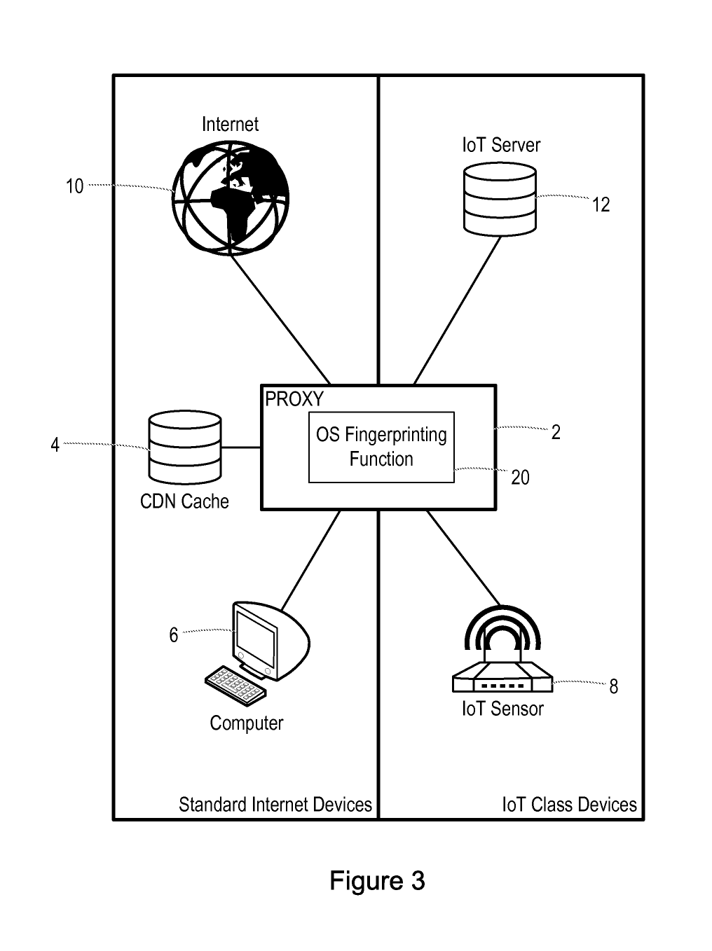

FIG. 3 is a schematic representation of an example of the method 100 of FIGS. 1 and 2 in operation. In the example of FIG. 3, a range of client devices including Standard Internet Devices 6, such as laptops, mobile phones etc, and IoT devices 8, such as sensors, are present in a residential or commercial environment. The different client devices are all connected to the same network, using the same access network technology and obtaining IP addresses from the same address space. As illustrated in the Figure, a proxy server 2 receives all traffic flows from the various client devices, and performs OS fingerprinting 20 to determine operating systems running on the devices 6, 8 sending the traffic flows. The determined operating system is mapped to a device category, which in the illustrated example comprises either Standard Internet Devices or IoT Devices. On the basis of the determined category, the received traffic flows are either routed over a separate and dedicated link to an IoT server 12, or routed via the standard paths to the internet 10, which may include optional caching in a CDN cache 4.

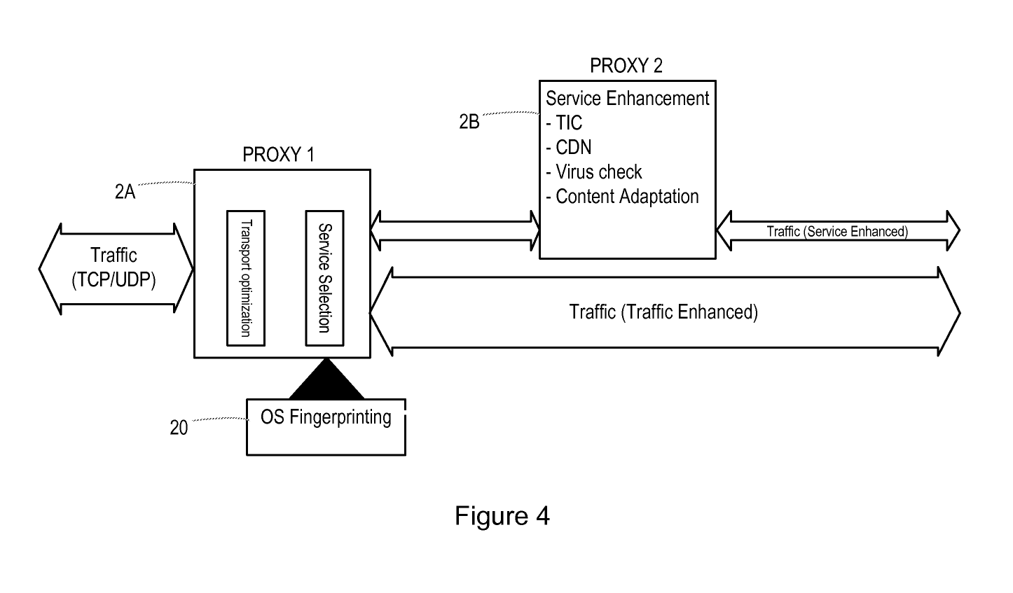

FIG. 4 is a schematic representation of another example of the method 100 of FIGS. 1 and 2 in operation. In the example of FIG. 4, two proxy nodes are present, a first proxy 2A, in which the example of the method 100 is performed, and a second proxy 2B in which various network optimisation service enhancements are performed. Referring to FIG. 4, traffic flows, which may be TCP or UDP traffic flows, are received at the first proxy 2A. OS fingerprinting 20, which may be augmented by additional identification information, permits the categorising of the client devices sending the traffic flows. The first proxy then retrieves a processing decision for each device category, the processing decision including the application or withholding of various processing functions including service optimisation and traffic optimisation. On the basis of the retrieved processing decision, the first proxy 2A may apply or withhold various traffic enhancements and then forwards the received traffic flows either to the second proxy 2B for one or more service enhancements, or directly to a next node in the forwarding route, bypassing the second proxy 2B and the service enhancements performed there.

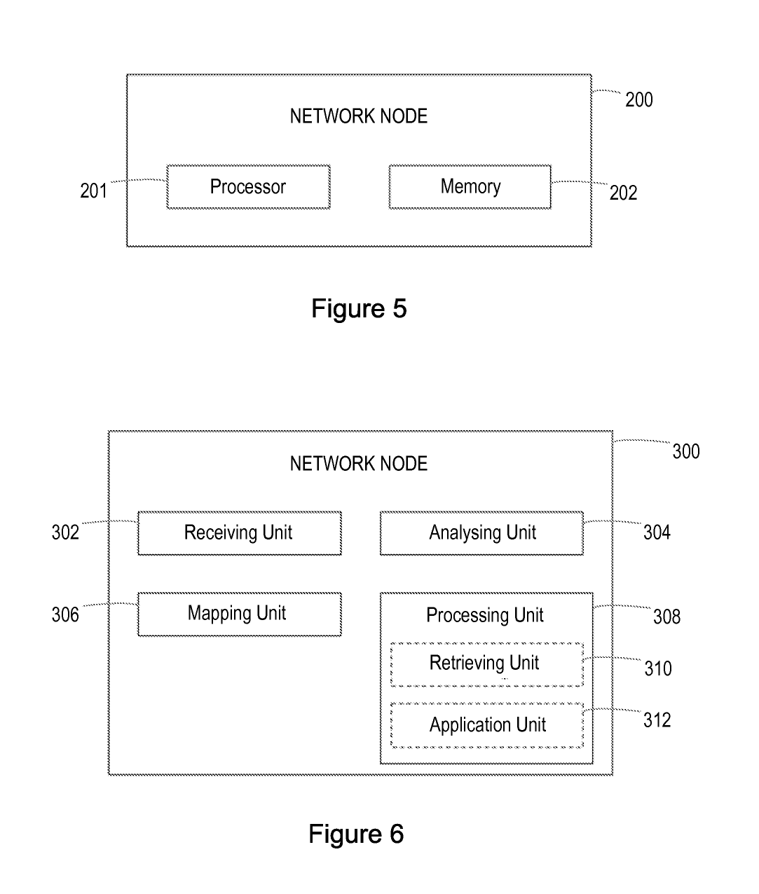

As discussed above, the method of the present invention may be conducted in a network node such as a proxy server. The method may be conducted on receipt of suitable computer readable instructions, which may be embodied within a computer program running on the network node. FIG. 5 illustrates a first example of a network node which may execute the method of the present invention, for example on receipt of suitable instructions from a computer program. Referring to FIG. 5, the network node 200 comprises a processor 201 and a memory 202. The memory 202 contains instructions executable by the processor 201 such that the network node 200 is operative to conduct the method 100 of FIGS. 1 and 2. The network node 200 may for example be a proxy server.

FIG. 6 illustrates functional units in another example of network node 300 which may execute the method 100 of the present invention, for example according to computer readable instructions received from a computer program. The network node 300 may for example be a proxy server. It will be understood that the units illustrated in FIG. 6 are functional units, and may be realised in any appropriate combination of hardware and/or software. The functional units may comprise one or more processors and one or more memories, and may be integrated to any degree.

Referring to FIG. 6, the network node 300 comprises a receiving unit 302 for receiving a traffic flow from a client device and an analysing unit 304 for analysing the received traffic flow to determine an operating system running on the client device. The analysing unit 304 may be for performing an operating system fingerprinting operation on the received traffic flow, which may be an active or a passive operating system fingerprinting operation. The network node 300 further comprises a mapping unit 306 for mapping the determined operating system to a client device category, and a processing unit 308 for implementing a processing decision for the received traffic flow according to the client device category.

The mapping unit 306 may be for inputting at least the determined operating system to a mapping function and retrieving a client device category from the mapping function. The mapping unit 306 may also be for obtaining at least one additional device identification information for the client device and inputting the additional device information to the mapping function.

The processing unit may comprise a retrieving unit 310 for retrieving a processing decision corresponding to the client device category from a memory, and an application unit 312 for applying the retrieved processing decision. The application unit 312 may also be for applying the retrieved processing decision for a traffic flow to the client device. The application unit 312 may be for performing at least one of applying or withholding a processing function corresponding to the processing decision.

Aspects of the present invention thus provide a method enabling traffic flows from different categories of client device to be identified and processed accordingly. In examples of the method in which passive fingerprinting techniques are used to determine an operating system running on the client device, the method may be entirely self contained within the network node, with no additional signalling involving either the client side or the server side of the node. The appropriate processing for the received traffic flows may therefore be implemented with no requirement for additional functionality in the client device or in application servers.

Advantages of the examples of the method of the present invention include reduced load on CDN nodes and other network optimisation functions, as only traffic flows that can make use of the network optimisation functions will be directed to those functions. Traffic that will not benefit from such optimisation functions runs transparently beside these functions, being routed more directly to its destination and so providing better performance for the originating devices. Additionally, optimisation functions are able to provide improved performance owing to the lower load placed upon them. Cell congestion conditions can also be more efficiently handled, with traffic measures being taken on the basis of client device categories to prioritise important traffic and make other processing decisions to ease the congestion conditions with the least impact to perceived network performance.

The methods of the present invention may be implemented in hardware, or as software modules running on one or more processors. The methods may also be carried out according to the instructions of a computer program, and the present invention also provides a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method, performed in a network node, for managing traffic received from a client device in a communication network, the method comprising:
receiving a traffic flow from a client device;
analysing the received traffic flow to determine an operating system running on the client device;
mapping the determined operating system to a client device category; and
implementing a processing decision for the received traffic flow according to the client device category.

2. The method as claimed in claim 1, wherein analysing the received traffic flow to determine an operating system running on the client device comprises performing an operating system fingerprinting operation on the received traffic flow.

3. The method as claimed in claim 2, wherein the operating system fingerprinting operation comprises one of an active or passive operating system fingerprinting operation.

4. The method as claimed in claim 1, wherein mapping the determined operating system to a client device category comprises inputting at least the determined operating system to a mapping function and retrieving a client device category from the mapping function.

5. The method as claimed in claim 4, wherein mapping the determined operating system to a client device category further comprises obtaining at least one additional device identification information for the client device and inputting the additional device information to the mapping function.

6. The method as claimed in claim 1, wherein implementing a processing decision for the received traffic flow according to the client device category comprises:
retrieving a processing decision corresponding to the client device category from a memory; and
applying the retrieved processing decision.

7. The method as claimed in claim 6, further comprising applying the retrieved processing decision for a traffic flow to the client device.

8. The method as claimed in claim 6, wherein applying the retrieved processing decision comprises at least one of applying or withholding a processing function corresponding to the processing decision.

9. The method as claimed in claim 8, wherein the processing function results in at least one of:
caching the received traffic flow;
adjusting a payload of the received traffic flow;
adjusting a speed of transmission of the received traffic flow; and
adjusting a forwarding route of the received traffic flow.

10. The method as claimed in claim 9, wherein adjusting a forwarding route of the received traffic flow comprises one of including or excluding a network optimisation function in the forwarding route of the received traffic flow.

11. The method as claimed in claim 10, wherein a network optimisation function comprises at least one of a Content Delivery Network, a virus check, Transparent Internet Caching, content adaptation.

12. The method as claimed in claim 9, wherein adjusting a forwarding route of the received traffic flow comprises including a Virtual Private Network in the forwarding route of the received traffic flow.

13. The method as claimed in claim 9, wherein adjusting a speed of transmission of the received traffic flow comprises selecting communication links for the received traffic flow having a different bandwidth.

14. The method as claimed in claim 9, wherein adjusting a speed of transmission of the received traffic flow comprises adjusting a priority with which the received traffic flow will be forwarded.

15. The method as claimed in claim 9, wherein adjusting a payload of the received traffic flow comprises performing at least one of data compression, Maximum Transmission Unit size adjustment, image resizing, content adaptation.

16. The method as claimed in claim 1, wherein the client device category categorises the client device according to at least one of:
device operating system;
device type;
device purpose;
device mobility;
device communication pattern;
associated devices;
associated equipment; and
network subscription.

17. The method as claimed in claim 1, wherein the network node comprises a proxy server.

18. A non-transitory computer readable storage medium having executable instructions stored therein, which when run on a computer causes the computer to execute a method comprising:
receiving a traffic flow from a client device;
analysing the received traffic flow to determine an operating system running on the client device;
mapping the determined operating system to a client device category; and
implementing a processing decision for the received traffic flow according to the client device category.

19. (canceled)

20. A network node for managing traffic received from a client device in a communication network, the network node comprising a processor and a memory, the memory containing instructions executable by the processor such that the network node is configured to:
receive a traffic flow from a client device;
analyse the received traffic flow to determine an operating system running on the client device;
map the determined operating system to a client device category; and
implement a processing decision for the received traffic flow according to the client device category.

21. A network node for managing traffic received from a client device in a communication network, the network node comprising:
a receiving unit for receiving a traffic flow from a client device;
an analysing unit for analysing the received traffic flow to determine an operating system running on the client device;
a mapping unit for mapping the determined operating system to a client device category; and
a processing unit for implementing a processing decision for the received traffic flow according to the client device category.

22. The network node as claimed in claim 21, wherein the analysing unit is for performing an operating system fingerprinting operation on the received traffic flow.

23. The network node as claimed in claim 22, wherein the analysing unit is for performing at least one of an active or passive operating system fingerprinting operation.

24. The network node as claimed in claim 21, wherein the mapping unit is for inputting at least the determined operating system to a mapping function and retrieving a client device category from the mapping function.

25. The network node as claimed in claim 24, wherein the mapping unit is for obtaining at least one additional device identification information for the client device and inputting the additional device information to the mapping function.

26. The network node as claimed in claim 21, wherein the processing unit comprises:
a retrieving unit for retrieving a processing decision corresponding to the client device category from a memory; and
an application unit for applying the retrieved processing decision.

27. The network node as claimed in claim 26, wherein the application unit is for applying the retrieved processing decision for a traffic flow to the client device.

28. The network node as claimed in claim 26, wherein the application unit is for performing at least one of applying or withholding a processing function corresponding to the processing decision.

29. The network node as claimed in claim 28, wherein the processing function results in at least one of:
caching the received traffic flow;
adjusting a payload of the received traffic flow;
adjusting a speed of transmission of the received traffic flow;
adjusting a forwarding route of the received traffic flow.

30. The network node as claimed in claim 29, wherein adjusting a forwarding route of the received traffic flow comprises one of including or excluding a network optimisation function in the forwarding route of the received traffic flow.

31. The network node as claimed in claim 30, wherein a network optimisation function comprises at least one of a Content Delivery Network, a virus check, Transparent Internet Caching, content adaptation.

32. The network node as claimed in claim 29, wherein adjusting a forwarding route of the received traffic flow comprises including a Virtual Private Network in the forwarding route of the received traffic flow.

33. The network node as claimed in claim 29, wherein adjusting a speed of transmission of the received traffic flow comprises selecting communication links for the received traffic flow having a different bandwidth.

34. The network node as claimed in claim 29, wherein adjusting a speed of transmission of the received traffic flow comprises adjusting a priority with which the received traffic flow will be forwarded.

35. The network node as claimed in claim 29, wherein adjusting a payload of the received traffic flow comprises performing at least one of data compression, Maximum Transmission Unit size adjustment, image resizing, content adaptation.

36. The network node as claimed in claim 21, wherein the client device category categorises the client device according to at least one of:
device operating system;
device type;
device purpose;
device mobility;
device communication pattern;
associated devices;
associated equipment; and
network subscription.

37. The network node as claimed in claim 21, wherein the network node comprises a proxy server.

38. A proxy server comprising a network node as claimed in claim 21.
